(19) United States
(12) Patent Application Publication
(10) Pub. No.: US 2002/0134023 A1
(43) Pub. Date: Sep. 26, 2002

(54) Door assembly including a rubber seal and a mechanical stop and seal

(75) Inventors: James DeTemple, Shillington, PA (US); Bruce Skipper, Mohnton, PA (US); Daniel Perlman, Auburn, PA (US)

Correspondence Address: SCHNADER HARRISON SEGAL & LEWIS, LLP, 1600 MARKET STREET, SUITE 3600, PHILADELPHIA, PA, 19103

(73) Assignee: Reading Body Works, Inc.

(21) Appl. No.: 09/815,994

(22) Filed: Mar. 23, 2001

(51) Int. Cl. E06B 7/16

(52) U.S. Cl. 49/472

(57) ABSTRACT

A door seal according to an embodiment of the invention includes a rubber seal and a mechanical seal. The rubber seal is a compressible, hollow body having a D-shaped longitudinal cross-section, affixed to the inner surface of a door which is adapted for contacting an outer surface of an associated door frame when in a closed position. The seal extends for substantially the entire perimeter of the door. A mechanical stop, extending from the door frame, engages said door, when in a closed position, to form a channel for directing water away from an opening formed by the door frame.

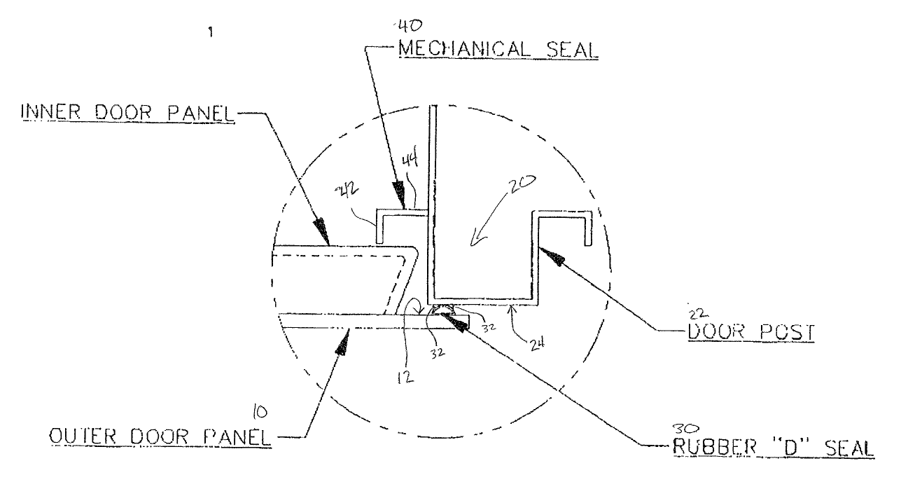

### BACKGROUND

1. Field of the Invention

The invention relates to door seals. More particularly, the invention relates to vehicular door seals. Most particularly, the invention relates to automotive, service body door seals.

2. Description of the Related Art

Better ways to keep tools and supplies from deleterious effects of weather and in particular, water are continually being sought. Modem vehicles such as trucks, trailers, and others are not immune from problems associated with water. If water is allowed to enter and accumulate in storage areas, tools become inoperable and supplies unusable. Thus, there is a continuing need for better storage areas and better seals to keep out the elements.

Service truck bodies often have doors which open to allow access to tools, parts, supplies, etc. These doors are normally made weather tight by applying a rubber seal that is fastened along the outer surface of the door frame opening. The seals are located in such a manner as to allow the door inner surface to contact and compress the seal, thus excluding water from entering the compartment. If water does travel beyond the rubber seal as a result of damaged seals or an improperly closed door, the water will typically enter the compartment and soak the contents.

This arrangement also leaves the delicate and important seals in a vulnerable location when the door is open. Heavy, bulky items such as lengths of chain, oak blocks, tool chests, etc. are lifted and dragged out of the compartments. Often, particularly upon returning the tools and other supplies, the door frame is hit or banged by the materials being returned. Because of the close proximity of the seal to the opening, the seal bears the brunt of this activity. This often leads to damage of the seal itself and reduces its ability to create a useful and water tight seal. The end result is undesirable leakage.

Accordingly, a better seal is needed, particularly for use in service truck bodies.

### SUMMARY OF THE INVENTION

A door seal according to an embodiment of the invention includes a rubber seal and a mechanical seal. The rubber seal is a compressible, hollow body having a D-shaped longitudinal cross-section, affixed to the inner surface of a door which is adapted for contacting an outer surface of an associated door frame when in a closed position. The seal extends for substantially the entire perimeter of the door. A mechanical stop, extending from the door frame, engages said door, when in a closed position, to form a channel for directing water away from an opening formed by the door frame.

### BRIEF DESCRIPTION OF THE DRAWING

The sole FIGURE is an exploded cross-sectional plan view of a closed door employing the door seal according to one embodiment of the invention.

### DETAILED DESCRIPTION

With reference to the FIGURE and reference numerals, a preferred embodiment of the invention will be described. Other variants of the invention will be apparent, and are considered to be part of the invention.

The seal is for use in storage compartments having a door 10 and a door frame 20. The door frame 20 may include door posts 22. The door frame 20 surrounds and defines an opening leading to a storage or other compartment. The door 10 is hingedly attached at one side to the door frame 20. The door 10 is sized such that an inner surface 12 of the door 10, preferably near and along substantially its entire perimeter, makes contact with an outer surface 24 of the door frame 20, preferably near and along substantially the entire perimeter thereof which defines the compartment opening.

To gain the most benefit from the seal arrangement, the door 10 preferably will be hinged such that it opens fully. This allows the door to open, and preferably be held, out of the way of the opening defined by the door frame 20. In and of itself, this reduces the likelihood of damage to the door 10 itself with parts and tools as they are removed or returned to the storage compartment.

The inventive seal has two main components, the first of which is a rubber seal 30 for hindering the passage of water into the storage compartment. The second is a mechanical stop and seal 40 which directs water away from the compartment.

The rubber seal 30 is affixed to the inner surface 12 of the door 10, extending substantially its entire perimetrical length where the door 10 contacts the door frame 20 in a closed position. When the door 10 is closed, the rubber seal 30 is compressed and effectively hinders unwanted leakage. To accomplish this, the rubber seal 30 is a hollow length of rubber tubing, preferably having a D-shaped longitudinal cross-section, with the flat portion affixed to the inner surface 12 of the door 10. To provide further protection against leaks, the rubber seal 30 is provided with at least one sealing fin 32, and preferably at least two. Each sealing fin 32, extends radially beyond the convex surface of the D-shaped rubber tubing, and extends longitudinally along substantially the entire length of the rubber tubing. Each sealing fin 32 provides further contact with the outer surface 24 of the door frame 20 thus providing another level of security against the passage of water.

As shown in the FIGURE, two sealing fins 32a, 32b preferably will be used. A first sealing fin 32a is present at an outer location and a second sealing fin 32b at an inner location. In this arrangement, the first sealing fin 32a makes contact with the door frame 20 and limits the amount of water passing through. The main seal is accomplished by the compressive contact of the convex portion of the D-shaped tubing of the rubber seal 30. The second fin 32b makes contact with the door frame 20 at a position closer to the compartment opening. Thus, in the preferred embodiment, there are three seals made between the rubber seal 30 on the door 10 and the door frame 20. Only if all three seals were defective or defeated will water pass through the rubber seal.

Notwithstanding the superior design of the rubber seal 30, it is possible that the rubber could become damaged, or that water may somehow seep through in small amounts. For this reason, the inventive seal also includes a mechanical seal 40. The mechanical seal 40 provides a mechanical stop by making contact with an inner surface 12 of the door, or as shown in the FIGURE with an inner door panel 14. When the door 10 is closed, the mechanical seal 40, door frame 20, and door 10 define a channel 50 through which any renegade water is directed to spare the contents of the cavity. Preferably, water is directed to an exterior point of exit to return the water back to the elements.

As shown, the mechanical seal 40 can be an extension of the door frame 20, having a cross-sectional L-shape. To be most effective, the mechanical seal will extend around substantially the entire perimetric length of the opening. The top portion of the mechanical seal 40 may have to be further adapted to hold and direct water away from the cavity and overcome gravity. A first portion 42 of the L-shaped extension is approximately perpendicular to the door 10, when closed. A second portion 44 is substantially parallel to the door 10 when closed, and connects the door frame 20 to the first portion 42. Preferably, water is directed through the channel 50 thus formed, and directed away from the cavity opening and to the ground below. It is possible that water could also be directed to a storage tank, but normally this would be avoided because of the extra weight associated with the storage tank and any water held.

The embodiment described above is not intended to limit the scope of the invention, but merely sets forth the preferred embodiment of the invention as currently contemplated by the inventors.

What is claimed is:

1. A door seal comprising:
a rubber seal comprising a compressible, hollow body having a D-shaped longitudinal cross-section, wherein said seal is affixed to the inner surface of a door which is adapted for contacting an outer surface of an associated door frame when in a closed position, wherein said seal extends for substantially the entire perimeter of said door; and
a mechanical stop which engages said door, when in a closed position, to form a channel for directing water away from an opening formed by the door frame.

2. The door seal of claim 1, wherein said rubber seal is provided with at least one sealing fin extending radially from the convex surface of said D-shaped rubber seal, for making additional contact with said outer surface of said door frame.

3. The door seal of claim 1, wherein said mechanical stop has an L-shaped vertical cross-section having a first portion perpendicular to the inner surface of said door and a second portion which is parallel to said door and connected to said door frame, thus defining a channel between said door, and said first and second portions of said mechanical stop for directing water from the opening defined by said door frame.
